(19) United States
(12) Patent Application Publication
(10) Pub. No.: US 2006/0272486 A1
(43) Pub. Date: Dec. 7, 2006

(54) Music editing method and related devices

(75) Inventors: Chia-Chun Chen, Taipei City (TW); Po-Yu Liang, Xiushui Shiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/143,093

(22) Filed: Jun. 2, 2005

(51) Int. Cl. G10H 1/38; G10H 7/00

(52) U.S. Cl. 84/637

(57) ABSTRACT

Music editing methods. A tonic chord is received. A group of candidate chords corresponding to the tonic chord is automatically retrieved. One of the candidate chords is selected, and a chord progressing of a music file is set with the tonic chord and the selected candidate chord in sequence.

### BACKGROUND

The present disclosure relates generally to music editing, and more particularly, to methods that edit chords, and related devices.

Traditionally, mobile phone devices play only monotonic ringtones, meaning that only one instrument or one note can be played at a time. To enrich ringtones with more instruments or notes, a mobile phone polyphonic ringer has been developed. With the mobile phone polyphonic ringer, the mobile phones can provide choral ringtones, in which several notes can be played simultaneously.

Conventionally, choral ringtones are edited track by track. FIG. 1 is a schematic diagram illustrating an example of a triad chord 100. Three tracks (110, 120, and 130) of the triad chord 100 are edited one by one, respectively shown in FIGS. 2A, 2B, and 2C. While editing each track, users however cannot see other tracks at the same time. Thus, unless they write down every note of each track in advance, users have no idea how to compose a complex triad chord. It makes users extremely difficult to edit music since it is critical to maintain the synchronization of each track. Additionally, the conventional method of editing music one track by another can be impractical for users who are not familiar with musical theory, causing errors when seeking harmonious musical chords.

### SUMMARY

Music editing methods are provided.

In an exemplary embodiment of a music editing method, a tonic chord is received. A group of candidate chords corresponding to the tonic chord is retrieved. One candidate chord is selected, and a music file generated according to the tonic chord and the selected candidate chord.

In an exemplary embodiment of a music editing method, a tonic chord is selected. A plurality of candidate chords corresponding to the tonic chord is automatically retrieved. A chord progressing of a music file on a device is set with the tonic chord and one of the candidate chords in sequence.

Music editing methods may take the form of program code embodied in tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an example of a triad chord;

FIGS. 2A, 2B and 2C are schematic diagrams illustrating three tracks of the triad chord in FIG. 1;

FIG. 3 is a flowchart of an embodiment of a music editing method;

FIG. 4A˜4G are schematic diagrams illustrating an example of a basic chord progressing rule;

FIGS. 5A, 5B and 5C are schematic diagrams illustrating an example of chord selection; and

FIGS. 6A and 6B are schematic diagrams illustrating examples of music editing interfaces.

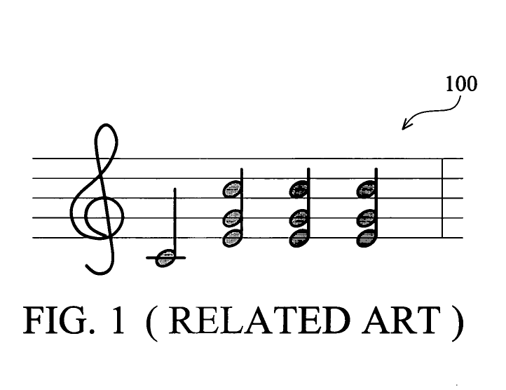

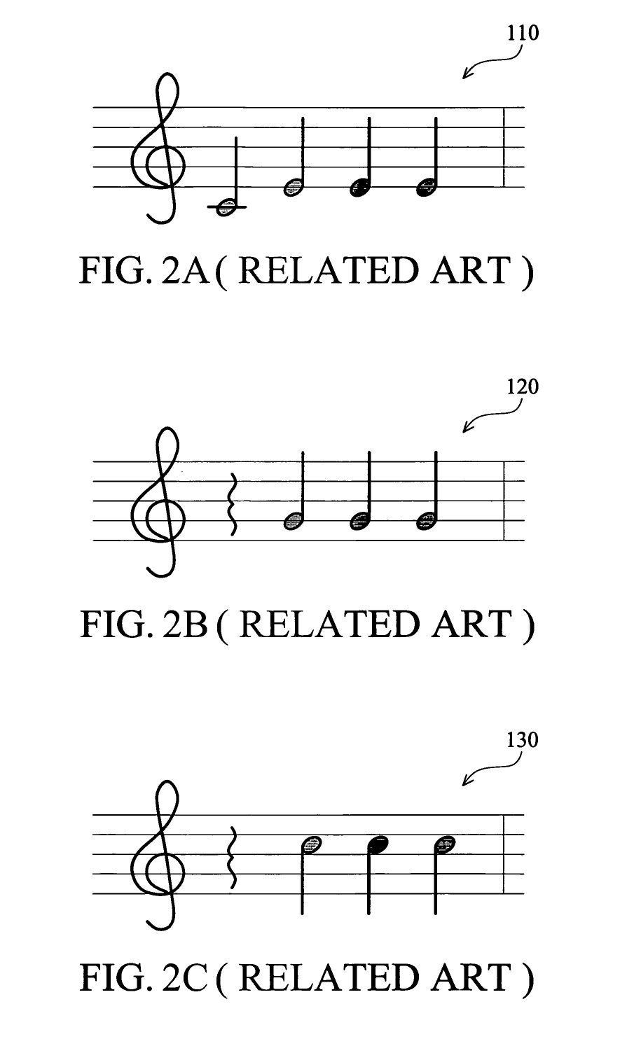

### DESCRIPTION

Music editing methods are provided.

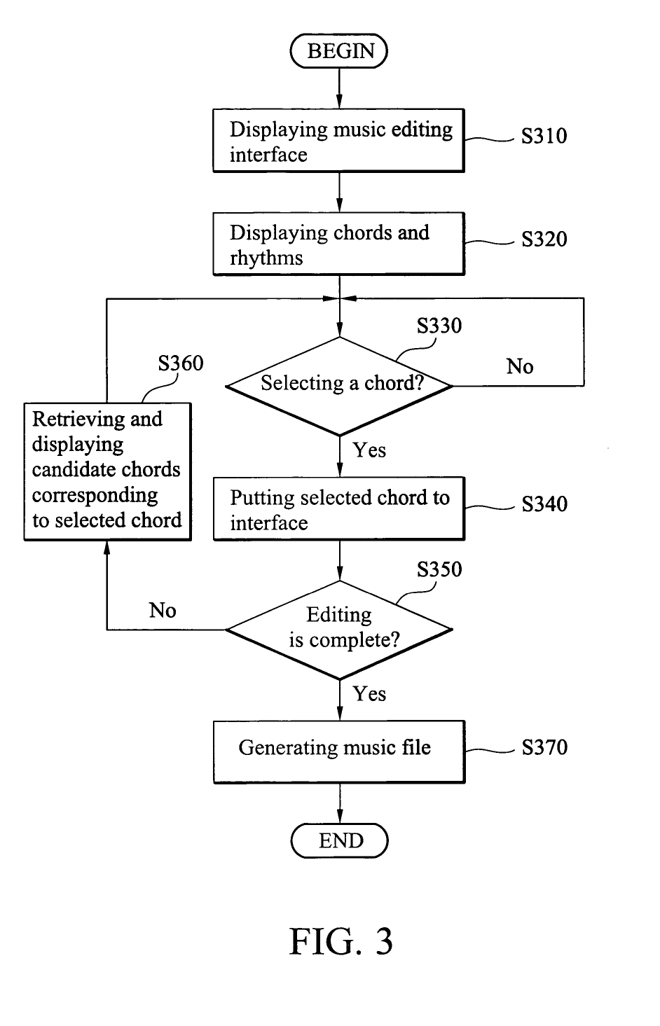

FIG. 3 is a flowchart of an embodiment of a music editing method. The music editing method is suitable for use in a device, such as a fixed phone, a mobile phone, a smart phone, and a PDA providing a choral ringtone capability. In some embodiments, choral ringtones are edited into MIDI files.

When editing a new music file, such as a MIDI file, in step S310, a music editing interface is displayed. The music editing interface could contain an empty polyphonic MIDI editing screen in which 24 chords and several rhythms are listed for selection. Here, the number of chords and rhythms can be predetermined according to users' needs, which is not limited in the present invention. In step S320, by the music editing interface, a plurality of chords and rhythms are displayed for selection. In some embodiments, the display style can be predetermined according to user's preference or a general selecting rate. In some embodiments, the 24 chords comprise 12 majors and 12 minors, such as C, D^{b}, D, E^{b}, E, F, F^{#}, G, A^{b}, A , B^{b}, B, c, c^{#}, d, d^{#}, e, f, f^{#}, g, g^{#}, a, b^{b}, and b chords, in which C, D^{b}, D, . . . , and b respectively represent a chord root. It is understood that the uppercase letters represent major chords, the letters in lower case represent minor chords, the superscript “b” represents a flat chord, and the superscript “#” represents a sharp chord. In some embodiments, the chords may be triad chords comprising augmented, major, minor, and diminished chords. It is noted that the augmented, major, minor, and diminished chords are respectively represented by a capital letter with a superscript “+”, a capital letter, a letter in lower case, and a letter in lower case with a superscript “°”. It is understood that the chords are not limited thereto, and other chords, such as seventh chords, ninth chords, eleventh chords, and others can be also applied in the invention.

In step S330, it is determined whether a chord is selected. If not, the procedure remains at step S330. If so, in step S340, the selected chord is provided to the music editing interface. In step S350, it is determined whether the editing process is completed. If not, in step S360, a plurality of candidate chords corresponding to the selected chord are automatically retrieved and displayed in the interface for next selection. Here, the candidate chords corresponding to each selected chord are predetermined. They are arranged according to a basic chord progressing rule stored in a database. Moreover, it is understood that, for the next selection, not only the chord, but also the rhythm for the chord can be changed. That is, the rhythms can be displayed for selection in step S360.

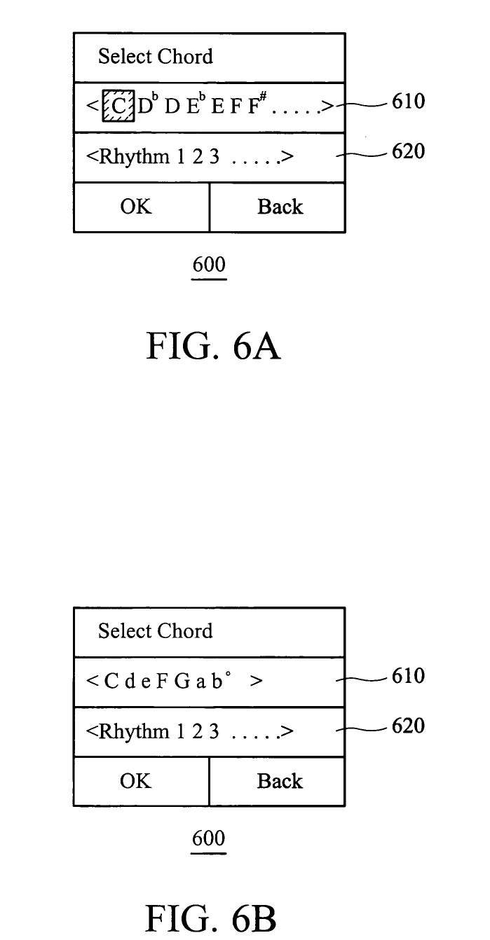

FIGS. 6A and 6B are schematic diagrams illustrating examples of music editing interfaces. In FIG. 6A, selectable chords and rhythms are respectively displayed in fields 610 and 620 of the interface 600. If chord C is selected, the candidate chords corresponding to chord C are displayed in the field 610 for selection, as shown in FIG. 6B.

In some embodiments, all chords and rhythms can be performed right after being selected so that users can listen and confirm whether the composition of the selected chords and rhythms is what they want. Steps S330˜S360 repeat until the editing is complete. If the editing is complete, in step S370, a music file comprising the selected rhythms and chords in sequence is generated. Therefore, different from the traditional track-by-track music editing method, the music editing method of the embodiment can generate music simply by selecting preferred chords and rhythms. Furthermore, the listing of candidate chords according to the basic chord progressing rule of the embodiment provides a visible guide to help accomplish the music editing.

If the selected chord is the first chord of the music file the selected chord is set as a tonic chord of the music file, and the candidate chords are retrieved according to the tonic chord and the basic chord progressing rule. It is understood that if a tonic is selected, seven degrees of notes can be determined. Similarly, seven degrees of chords can be determined based on the tonic chord. The first to seventh degree chords are respectively tonic, super-tonic, mediant, sub-dominant, dominant, sub-mediant, and leading-tone chords. Particularly for major tonic chords, the first to seventh degrees of chords corresponding to the tonic chord are I, ii, iii, IV, V, vi, and vii° chords, respectively. For minor chords, the seven degrees of chords corresponding to the tonic chord are i, ii°, III⁺, iv, V, VI, and vii° chords, respectively.

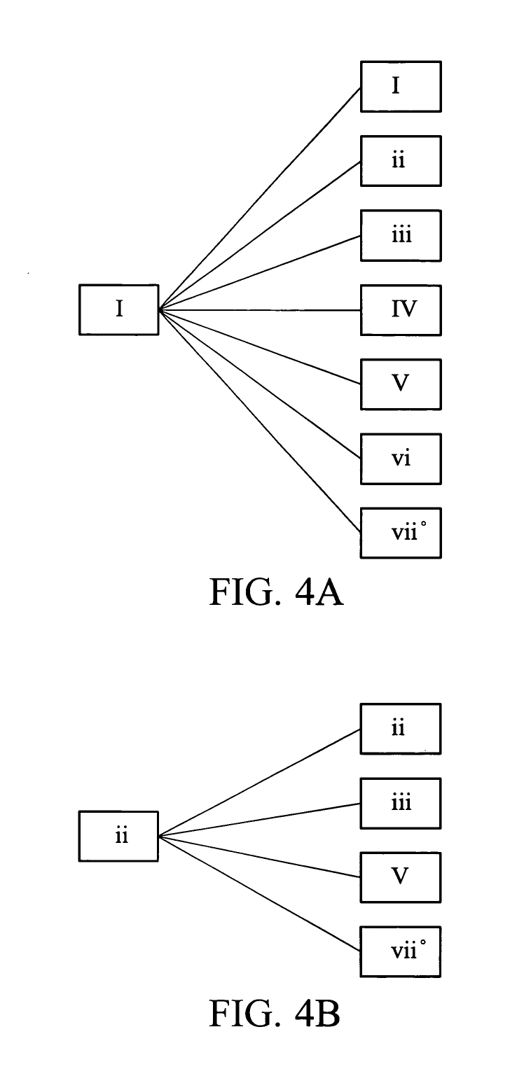

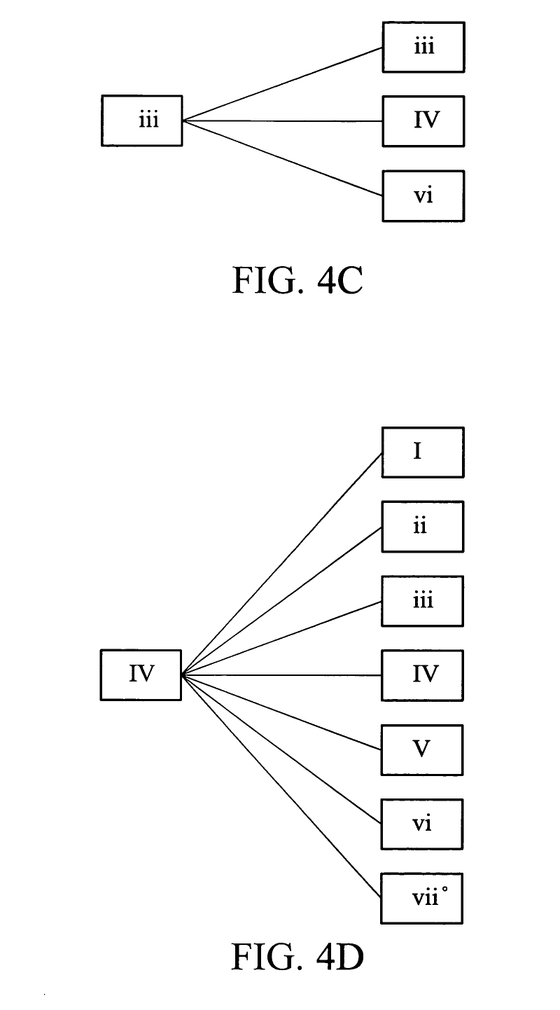

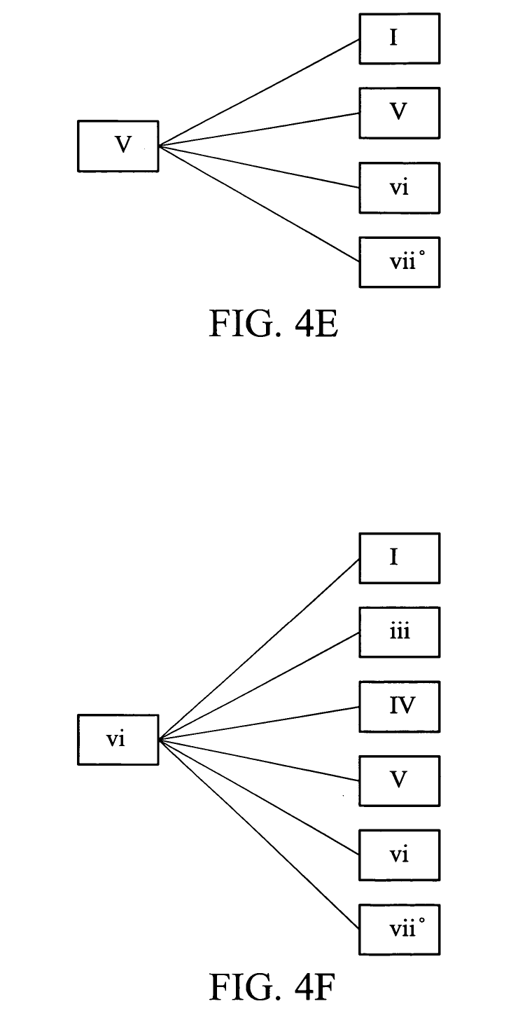

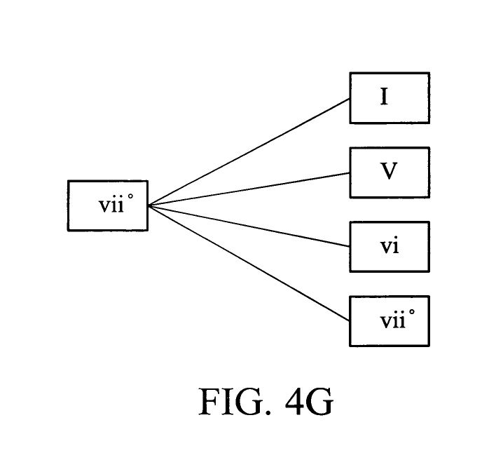

The basic chord progressing rule defines to what degree chords can follow with a specific degree chord. FIGS. 4A˜4G are schematic diagrams illustrating an example of a basic chord progressing rule. As shown in FIGS. 4A˜4G, according to the basic chord progressing rule, chords major tonic (I), minor super-tonic (ii), minor mediant (iii), major sub-dominant (IV), major dominant (V), minor sub-mediant (vi), and minor leading-tone (vii°) can follow with chord tonic (I), chords ii, iii, V, and vii° can follow with chord ii, chords iii, IV, and vi can follow with chord iii, chords I, ii, iii, IV, V, vi, and vii° can follow with chord IV, chords I, V, vi, and vii° can follow with chord V, chords I, iii, IV, V, vi, and vii° can follow with chord vi, and chords I, V, vi, and vii° can follow with chord vii°. It is understood that the chord progressing rule is only an example, not limited thereto. In this example, if the tonic chord is selected, a major tonic chord, a minor super-tonic chord, a minor mediant chord, a major sub-dominant chord, a major dominant chord, a minor sub-mediant chord, and a diminished leading-tone chord respectively corresponding to the tonic chord, are automatically retrieved for selection. If a minor super-tonic chord corresponding to the tonic chord is selected, the minor super-tonic chord, a minor mediant chord, a major dominant chord, and a diminished leading-tone chord, respectively corresponding to the tonic chord, are automatically retrieved for selection. If a minor mediant chord corresponding to the tonic chord is selected, the minor mediant chord, a major sub-dominant chord, and a minor sub-mediant chord, respectively corresponding to the tonic chord, are automatically retrieved for selection. If a major sub-dominant chord corresponding to the tonic chord is selected, a major tonic chord, a minor super-tonic chord, a minor mediant chord, the major sub-dominant chord, a major dominant chord, a minor sub-mediant chord, and a diminished leading-tone chord, respectively corresponding to the tonic chord, are automatically retrieved for selection. If a major dominant chord corresponding to the tonic chord is selected, a major tonic chord, the major dominant chord, a minor sub-mediant chord, and a diminished leading-tone chord, respectively corresponding to the tonic chord, are automatically retrieved for selection. If a minor sub-mediant chord corresponding to the tonic chord is selected, a major tonic chord, a minor mediant chord, a major sub-dominant chord, a major dominant chord, the minor sub-mediant chord, and a diminished leading-tone chord, respectively corresponding to the tonic chord, are automatically retrieved for selection. If a diminished leading-tone chord corresponding to the tonic chord is selected, a major tonic chord, a major dominant chord, a minor sub-mediant chord, and the diminished leading-tone chord, respectively corresponding to the tonic chord, are automatically retrieved for selection.

In some embodiments, if the tonic chord is C, the I, ii, iii, IV, V, vi, and vii° are C, d, e, F, G, a and b°, respectively. If the tonic chord is D^{b}, the I, ii, iii, IV, V, vi, and vii° are D^{b}, e^{b}, f, G^{b}, A^{b}, b^{b} and c°, respectively. If the tonic chord is D, the I, ii, iii, IV, V, vi, and vii° are D, e, f^{#}, G, A, b and c^{#}°, respectively. If the tonic chord is E^{b}, the I, ii, iii, IV, V, vi, and vii° are E^{b}, f, g, A^{b}, B^{b}, c and d°, respectively. If the tonic chord is E, the I, ii, iii, IV, V, vi, and vii° are E, f^{#}, g^{#}, A, B, C^{#} and d^{#}°, respectively. If the tonic chord is F, the I, ii, iii, IV, V, vi, and vii° are F, g, a, B^{b}, C, d and e°, respectively. If the tonic chord is F^{#}, the I, ii, iii, IV, V, vi, and vii° are F^{#}, g^{#}, a^{#}, B, C^{#}, d^{#} and e^{#}°, respectively. If the tonic chord is G, the I, ii, iii, IV, V, vi, and vii° are G, a, b, C, D, e and f^{#}°, respectively. If the tonic chord is A^{b}, the I, ii, iii, IV, V, vi, and vii° are A^{b}, b^{b}, c, D^{b}, E^{b}, f and g°, respectively. If the tonic chord is A, the I, ii, iii, IV, V, vi, and vii° are A, b, c^{#}, D, E, f^{#} and g^{#}°, respectively. If the tonic chord is B^{b}, the I, ii, iii, IV, V, vi, and vii° are B^{b}, c, d, E^{b}, F, g and a°, respectively. If the tonic chord is B, the I, ii, iii, IV, V, vi, and vii° are B, c^{#}, d^{#}, E, F^{#}, g^{#} and a^{#}°, respectively. If the tonic chord is c, the i, ii°, III⁺, iv, V, VI, and vii° are c, d°, E^{b+}, f, G, A^{b} and b°, respectively. If the tonic chord is c^{#}, the i, ii°, III⁺, iv, V, VI, and vii° are c^{#}, d^{#}°, E⁺, f^{#}, G^{#}, A and b^{#}°, respectively. If the tonic chord is d, the i, ii°, III⁺, iv, V, VI, and vii° are d, e°, F⁺, g, A, B^{b} and c^{#}°, respectively. If the tonic chord is d^{#}, the i, ii°, III⁺, iv, V, VI, and vii° are d^{#}, e^{#}°, F^{#+}, g^{#}, A^{#}, B and c^{#}°, respectively. If the tonic chord is e, the i, ii°, III⁺, iv, V, VI, and vii° are e, f^{#}°, G⁺, a, B, C and d^{#}°, respectively. If the tonic chord is f, the i, ii°, III⁺, iv, V, VI, and vii° are f, g°, A^{b+}, b^{b}, C, D^{b} and e°, respectively. If the tonic chord is f^{#}, the i, ii°, III⁺, iv, V, VI, and vii° are f^{#}, g^{#}°, A⁺, b, C^{#}, D and e^{#}°, respectively. If the tonic chord is g, the i, ii°, III⁺, iv, V, VI, and vii° are g, a°, B^{b+}, c, D, E^{b} and f^{#}°, respectively. If the tonic chord is g^{#}, the i, ii°, III⁺, iv, V, VI, and vii° are g^{#}, a^{#}°, B⁺, c^{#}, D^{#}, E and f^{#}°, respectively. If the tonic chord is a, the i, ii°, III⁺, iv, V, VI, and vii° are a, b°, C⁺, d, E, F and g^{#}°, respectively. If the tonic chord is b^{b}, the i, ii°, III⁺, iv, V, VI, and vii° are b^{b}, c°, D^{b+}, e^{b}, F, G^{b} and a°, respectively. If the tonic chord is b, the i, ii°, III⁺, iv, V, VI, and vii° are b, c^{#}°, D⁺, e, F^{#}, G and a^{#}°, respectively. It is understood that the chords are not limited thereto.

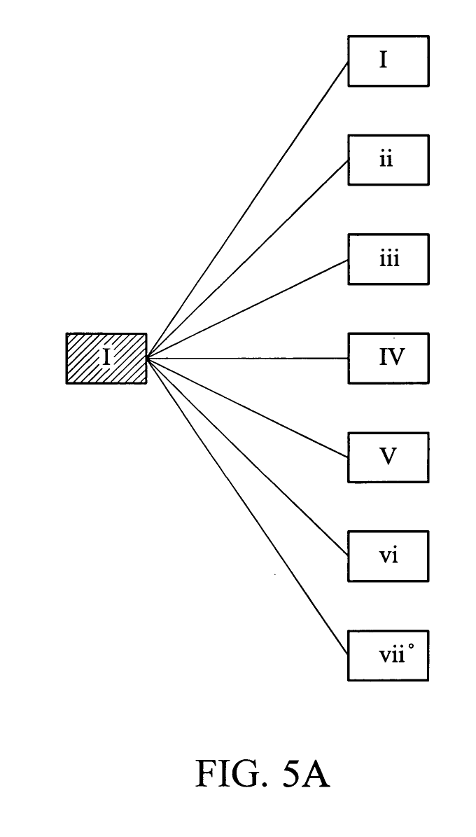

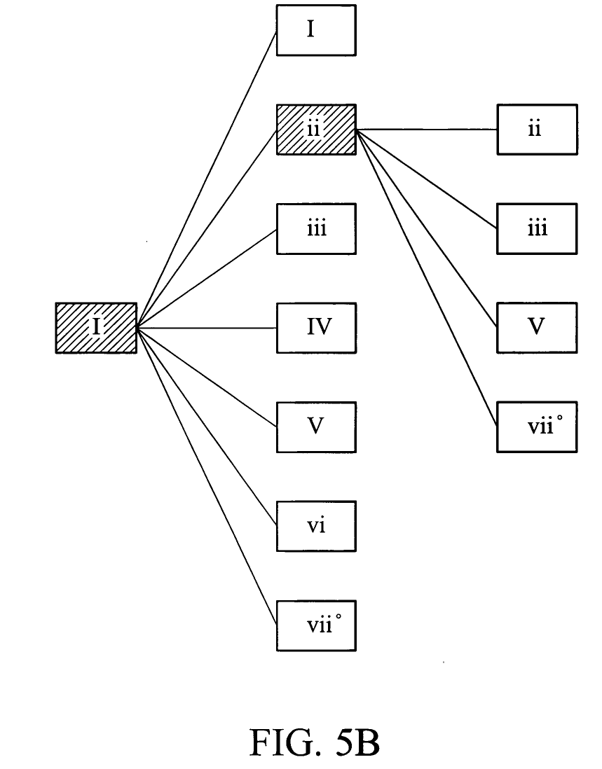

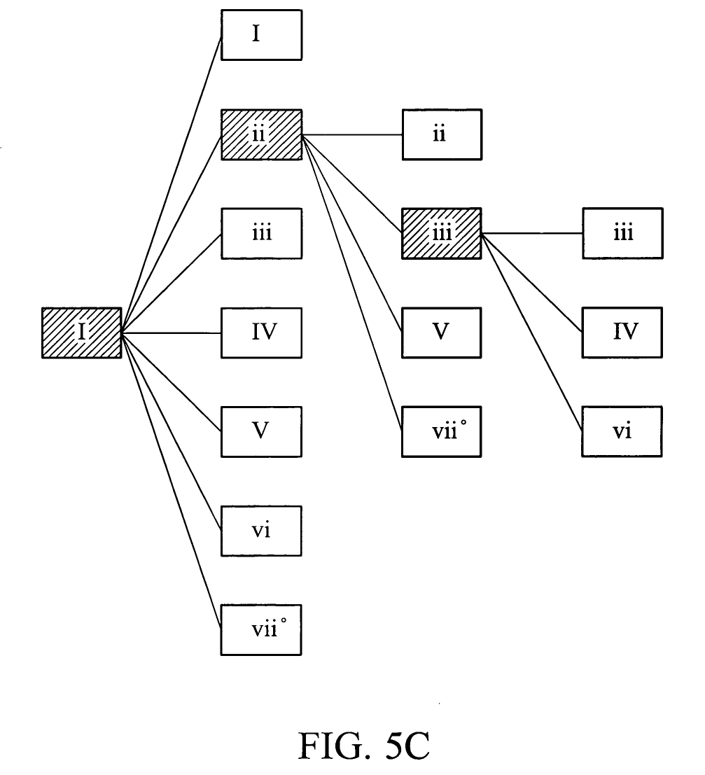

FIGS. 5A, 5B and 5C are schematic diagrams illustrating an example of chord selection. If chord I is selected, chords I, ii, iii, IV, V, vi, and vii° are retrieved and displayed for selection, as shown in FIG. 5A. If chord ii is then selected, chords ii, iii, V, and vii° are retrieved and displayed for selection, as shown in FIG. 5B. If chord iii is then selected, chords iii, IV, and vi are retrieved and displayed for selected, as shown in FIG. 5C.

Music editing methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A music editing method, comprising:
selecting a tonic chord;
retrieving a first group of candidate chords corresponding to the tonic chord;
selecting one of the candidate chords; and
generating a music file according to the tonic chord and the selected candidate chord.

2. The method of claim 1 further comprising setting a chord progressing of the music file by setting the tonic chord and the selected candidate chord in sequence.

3. The method of claim 1 further comprising:
providing a plurality of rhythms;
selecting one of the rhythms; and
generating the music file according to the tonic chord, the selected candidate chord, and the selected rhythm.

4. The method of claim 1 further comprising providing an interface displaying the candidate chords.

5. The method of claim 1 further comprising retrieving the candidate chords corresponding to the tonic chord according to a chord progressing rule.

6. The method of claim 1 further comprising retrieving a second group of candidate chords corresponding to the selected candidate chord.

7. The method of claim 1 further comprising retrieving triad chords for the candidate chords.

8. The method of claim 1 further comprising retrieving augmented, major, minor, or diminished chords for the candidate chords.

9. A music editing method for use in a device, comprising:
selecting a tonic chord; and
retrieving a plurality of candidate chords corresponding to the tonic chord,
wherein a chord progressing of a music file on the device is set with the tonic chord and one of the candidate chords in sequence.

10. The method of claim 9 further comprising:
selecting a rhythm; and
generating the music file according to chord progressing and the rhythm.

11. The method of claim 9 further comprising retrieving the candidate chords corresponding to the tonic chord according to a chord progressing rule.

12. The method of claim 9 further comprising:
selecting one of the candidate chords;
retrieving a second group of candidate chords corresponding to the selected candidate chord.

13. The method of claim 9 further comprising retrieving triad chords for the candidate chords.

14. The method of claim 9 further comprising retrieving augmented, major, minor, or diminished chords for the candidate chords.

15. A device, comprising:
means for selecting a tonic chord;
means for retrieving a first group of candidate chords corresponding to the tonic chord;
means for selecting one of the candidate chords; and
means for generating a music file according to the tonic chord and the selected candidate chord.

16. The device of claim 15 further comprising:
means for providing a plurality of rhythms;
means for selecting one of the rhythms; and
means for generating the music file according to the tonic chord, the selected candidate chord, and the selected rhythm.

17. The device of claim 15 being a mobile phone, a smart phone, or a PDA.

18. A device, comprising:
means for selecting a tonic chord; and
means for retrieving a plurality of candidate chords corresponding to the tonic chord,
wherein a chord progressing of a music file on the device is set with the tonic chord and one of the candidate chords in sequence.

19. The device of claim 18 further comprising:
means for selecting a rhythm; and
means for generating the music file according to chord progressing and the rhythm.

20. The device of claim 18 being a mobile phone, a smart phone, or a PDA.
